(19) United States
(12) Patent Application Publication
(10) Pub. No.: US 2005/0055688 A1
(43) Pub. Date: Mar. 10, 2005

(54) Integrated rapid install system for generic software images

(76) Inventors: Gaston M. Barajas, Austin, TX (US); William P. Hyden, Round Rock, TX (US); Gavin T. Smith, Kyle, TX (US); Thomas Vrhel JR., Woodinville, WA (US)

Correspondence Address: Stephen A. Terrile;HAMILTON & TERRILE, LLP, PO Box 203518, Austin, TX, 78720, US

(21) Appl. No.: 10/657,374

(22) Filed: Sep. 8, 2003

(51) Int. Cl. G06F 9/445

(52) U.S. Cl. 717/174; 717/176

(57) ABSTRACT

A method for automatically installing a software image onto an information handling system. The method includes reading an order for an information handling system, reading an image manifest, installing an image specified by the image manifest onto the information handing system as installed software, and automatically configuring the installed software.

### BACKGROUND OF THE INVENTION

1. Field of the Invention

The present invention relates to the field of information handling systems and more particularly to automated generation of configurable software images.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more information handling systems, data storage systems, and networking systems.

It is known to install software and to perform tests on information handling systems before they are shipped to businesses or individual customers. A goal of software installation is to efficiently produce a useful, reliable information handling system. Software installation often includes loading a desired package of software onto the information handling system, preparing appropriate environment variables for the information handling system, and preparing appropriate initialization files for the loaded software.

When installing hardware and software onto multiple information handling systems in a manufacturing environment, identifying a unique software or hardware order across multiple information handling systems is desirable. A software order is unique if all the software parts and parameters that are installed in a system are unique in combination. A hardware order is unique when all of the hardware parts of that order are unique in combination.

Installable images have been identified as a means for reducing system setup times while also providing well tested, self contained packages to be deployed as a whole to a client system. To support flexibility in a build to order environment, a large number of images need to be created and refreshed. This is especially important when a new version of an operating system becomes available.

In known systems, images are created using operators to setup a machine by hand using install CDs for the operating system and applications. The system is then configured as desired. The image is then created using a software tool such as that available from Norton under the trade designation “Ghost” or from Powerquest under the trade designation “Drive Image Pro (PQI)”.

The use of a layering process is network intensive due to continual open/read/close interaction with network services. Known processes for developing images are non-deterministic because any individual layered component within the image can change without any change management processes being used. The use of a network and the lack of managed deterministic system builds make it necessary that a manufacturer's system production remain within the manufacturer's factory. However, in certain situations, it may be desirable to ship an image to an OEM to enable the OEM to manufacture a system which has customized to order features and thus to enable the image to be customized to a customer's specification.

Accordingly, it is desirable to provide a system with the ability of automatically generating images, thus allowing images to be created continuously and then tested when schedules permit.

### SUMMARY OF THE INVENTION

In accordance with the present invention, an integrated rapid installation system is provided. More specifically, with the integrated rapid installation system, an image for installation onto a target system is self contained and includes substantially all current shipping software parts for predetermined target system orders. The image includes a fully configured base operating system, an installed application and possibly install source for additional software available to the target system.

The integrated rapid installation system reduces factory customization time and reduces reliance on potentially high cost network/server infrastructure while allowing for change management and deterministic testing. Additionally, because the image contains substantially all of the possible software components in an order, the image can be used in many different types of manufacturing methods. For example, the image can be delivered over a network, by hard drive duplication, via CD/DVD (or other non-volatile media) install, or via drive to drive copying. Thus, the integrated rapid installation system enables images to be provided to other types of factories such as original equipment manufacturer factories (OEM), low overhead (e.g., non-network) factories while maintaining a high quality software image installation in a customized to order (CTO) business model.

In one embodiment, the invention relates to a method for automatically installing a software image onto an information handling system. The method includes reading an order for an information handling system, reading an image manifest, installing an image specified by the image manifest onto the information handing system as installed software, and automatically configuring the installed software.

In another embodiment, the invention relates to an apparatus for automatically installing a software image onto an information handling apparatus. The apparatus includes means for reading an order for an information handling system, means for reading an image manifest, means for installing an image specified by the image manifest onto the information handing system as installed software, and means for automatically configuring the installed software.

In another embodiment, the invention relates to a system for automatically installing a software image onto an information handling system. The system includes a reading module, the reading module reading an order for an information handling system, an image manifest module, the image manifest module reading an image manifest, an installing module, the installing module installing an image specified by the image manifest onto the information handing system as installed software, and a configuring module, the configuring module automatically configuring the installed software.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a block diagram of a plurality of manufacturing sites providing information relating to orders.

FIG. 3 shows a flow chart of the operation of an integrated rapid install system for generic software images.

FIG. 4 shows a process flow for the software stack generator machine.

FIG. 5 shows a flow chart of the operation of a system for identifying unique orders.

FIG. 6 shows a system block diagram of an information handling system having a unique order configuration.

### DETAILED DESCRIPTION

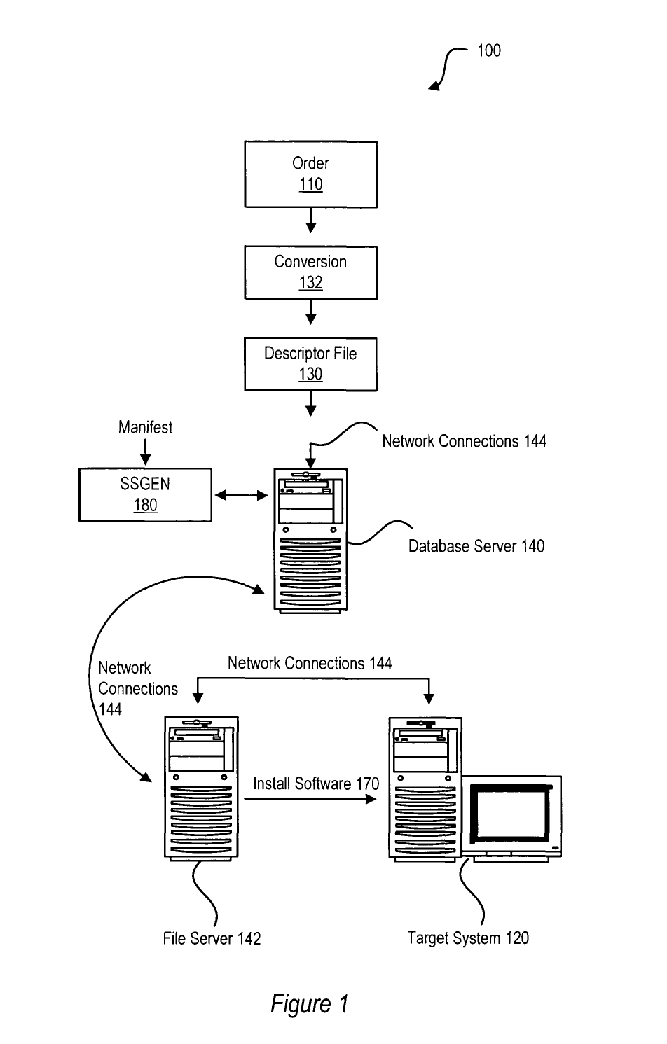

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components may require different software installations, it is desirable to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides an image having a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120 via file server 142. The software is installed on the target information handling system via the image. The image may include self-configuring code.

The database server 140 may also be updated via a software stack generator machine 180. The software stack generator (SSGEN) machine 180 is capable of downloading and installing a configurable set of software parts and then automatically capturing an image of the contents, optionally uploading the image to a shared server such as the database server 140 for later use. The software stack generator machine 180 is capable of being controlled by a centralized front end, thus allowing two or more software stack generator machines to be set up in an image building farm.

In operation, the automating the generation of images provides the ability to download the parts to be installed into the image from a network or other storage device. The software stack generator machine 180 may include scriptable package delivery mechanisms. The software stack generator machine 180 may include or receive images which include an integrated rapid install system (IRIS). The integrated rapid install system may then be installed onto the target system when the image is installed onto the target system.

Images to be created are described using a manifest which is represented, e.g., as an XML document. The contents of the image include some or all of a base operating system, application programs, applets (for hardware), etc. The manifest is provided to the software stack generator machine 142 and causes the image building process to begin. After the image is created, the image can be installed onto a target system 120 such that the building of the image is transparent to the target system. For example, the SSGEN machine 180 removes anything from the registry of the operating system that would indicate that the software stack was created by the SSGEN machine 180.

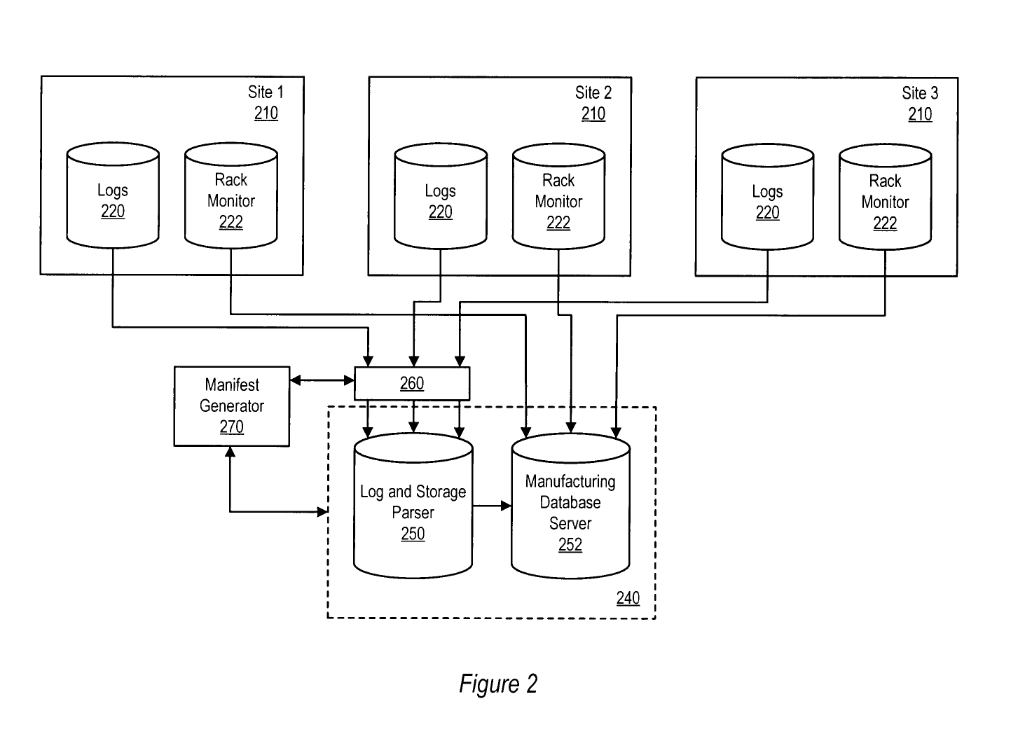

Referring to FIG. 2, a block diagram of a plurality of manufacturing sites providing information relating to orders and a system for automated generation of config to order software stacks is shown. More specifically, the plurality of manufacturing sites 210 each include a respective log database 220 and burn rack monitor database 222. Information from the log databases 220 and the burn rack monitor databases 222 are provided to an order storage system 240. The order storage system includes a log storage and parser server 250 and a manufacturing database server 252. The log storage and parser server 250 and the manufacturing database server 252 may be located on one or more servers. The log storage and parser server 250 receives information from the log databases 220 and the manufacturing database server 252 receives information from the burn rack monitor database 222. The information that is provided to the log storage and parser database 250 passes through a system for calculating and identifying unique orders 260.

The system for calculating and identifying unique orders 260 packages a plurality of different system configurations in a unique and easily identifiable identifier. Providing a unique and easily identifiable identifier for each unique order configuration enables analysis of the order configuration to determine the frequency of certain order configurations as well as ranking of certain order configurations. Such identification and ranking enables pre-combination of certain commonly ordered configurations so as to expedite the manufacturing and loading process.

A manifest generator 270 is coupled to the order storage system 240 to obtain information for generating manifests. The system for calculating and identifying unique orders 260 may provide information to a manifest generator 270. The manifest generator 270, which generates the manifests for input to the SSGEN machine 180, may use the information from the system for calculating and identifying unique orders 260 to prioritize the generation of manifests and thus the creation of software stacks by the SSGEN machine 180. The software stacks that are developed by the SSGEN machine 180 may include self configuring system information which is used by the integrated rapid install system.

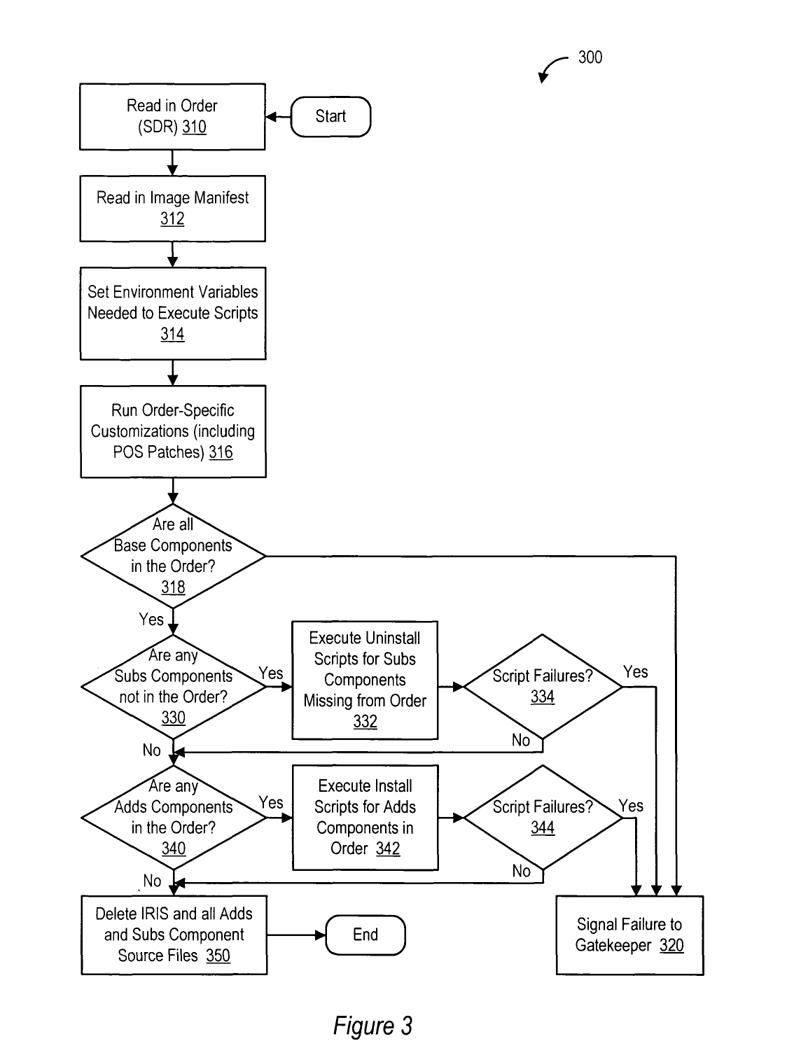

Referring to FIG. 3, a flow chart of the operation of an integrated rapid install system 300 for generic software images is shown. More specifically, the integrated rapid install system 300 starts by reading in an order for an information handling system at step 310. In a preferred embodiment, the order is read in via a system descriptor record (SDR). After the order is read, then an image manifest corresponding to the order is read at step 312. The image manifest includes descriptions and instructions for the installation, removal and/or configuration of optional software components.

After the image manifest is read, then the integrated rapid install system 300 sets any environment variables that may be needed to execute scripts that are included within the image at step 314. Examples of environment variables that may be set include operating system environment variables, language environment variables, and manufacturing site environment variables.

Next, order specific customizations are executed at step 316. Order specific patches include customer-based operating system customization. Other examples of order specific customizations include keyboard language settings.

Next, the image is reviewed to determine whether all of the base components from the order are present. Examples of base components include the operating system for the target system 120 and installed applications for the target system. If all of the base components are not present, then the integrated rapid install system 300 indicates a failure to the gatekeeper at step 320. The gatekeeper indicates a failure to the controlling manufacturing process. If all of the base components of the order are present then the integrated rapid install system 300 transfers to step 330.

During step 330, the integrated rapid install system 300 determines whether there are any subtract components present in the order. Subtract components are components that are present in the image that are not included within the order, and thus are to be deleted while the image is installed onto the target system 120. If there are any subtract components present in the order, then the integrated rapid install system 300 executes uninstall scripts for the subtract components that are missing from the order at step 332. The integrated rapid install system 300 then determines whether any script failures arose during the execution of the scripts at step 334. If a script failure did occur, then the integrated rapid install system 300 indicates a failure to the gatekeeper at step 320. If there were no script failures, then the integrated rapid install system 300 transfers to step 340.

During step 340, the integrated rapid install system 300 determines whether there are any add components present in the order. Add components are components that are present in the image as source code that are to be included within the order, and thus are to be installed while the image is installed onto the target system 120. If there are any add components present in the order, then the integrated rapid install system 300 executes install scripts for the add components that are to be added to the order at step 342. The integrated rapid install system 300 then determines whether any script failures arose during the execution of the scripts at step 344. If a script failure did occur, then the integrated rapid install system 300 indicates a failure to the gatekeeper at step 320. If there were no script failures, then the integrated rapid install system 300 transfers to step 350.

During step 350, the integrated rapid install system 300 deletes all add and subtract components source files and then the integrated rapid install system 300 deletes itself and the execution of the integrated rapid install system 300 completes.

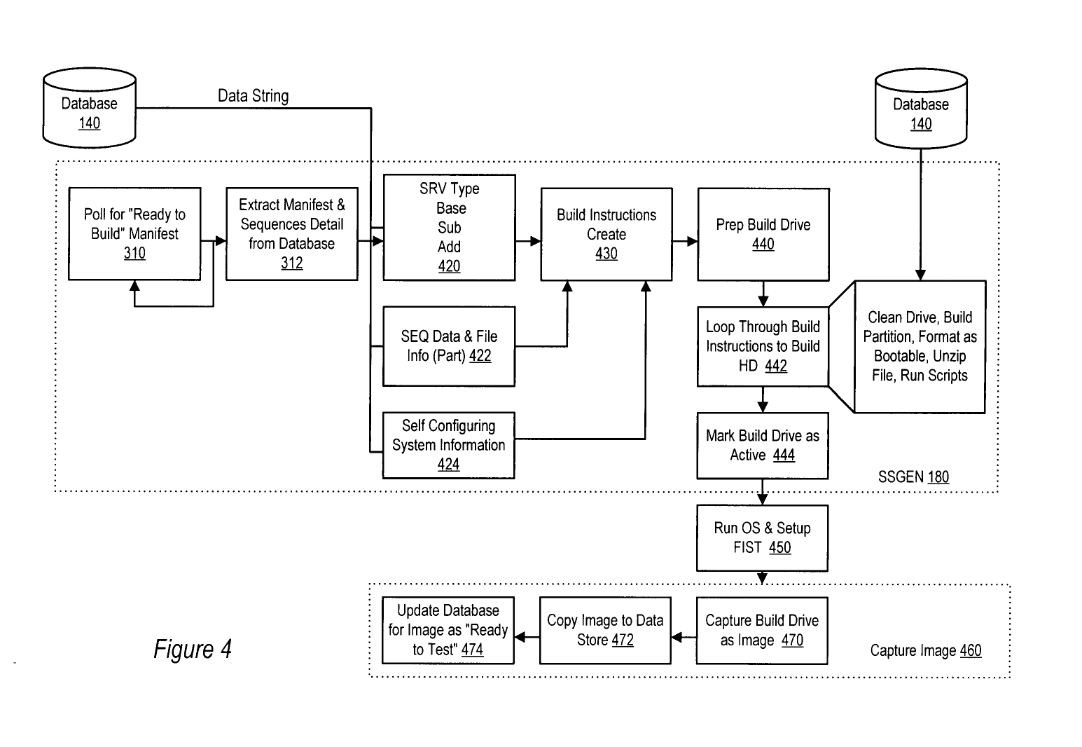

Referring to FIG. 4, a process flow for the software stack generator machine is shown. More specifically, the SSGEN machine 180 polls for manifests at step 310. The SSGEN machine then extracts manifest information and sequences detail from the database 140 at step 312 via a data string. The manifest information includes SRV type information 420, SEQ data and file information and infopart information 422 as well as self configuring system information 424. The self configuring system information 424 may then be used by the integrated rapid install system 300 when installing images onto the target system 120. The SRV type information may include whether a piece of software is a base type, a sub type or an add type. A base type of software is preconfigured static software. An add type of software is software that may be installed and configured. A sub type of software is software that is already installed on the system and can be uninstalled during the self configuration of the system.

The software stack generator machine 180 uses this information to create build instructions as step 430. The software stack generator machine 180 then prepares a build drive within the software stack generator machine 180 at step 440. The software stack generator machine then loops through the build instructions to build a software stack for a hard drive at step 442 from software that is stored within a database such as database 140. The looping includes cleaning the drive of any extraneous information, building a partition on the drive, formatting the drive as bootable, decompressing (e.g., unzipping) the install software and executing scripts to install the software. After all of the software from the manifest is installed, then the software stack generator machine 180 identifies the drive as active at step 444.

Next the target operating system is executed and setup and configured at step 450. The operating system set up may be executed during system development or within the factory. Alternately, if the operating system is a fixed image, then the operating system set up may be executed at a customer location.

Next the process enters an image capture portion 460. During the image capture portion, the build drive is captured as an image at step 470. The captured image is then copied to a data store at step 472. The database is then updated to identify the copied image as ready to test at step 474.

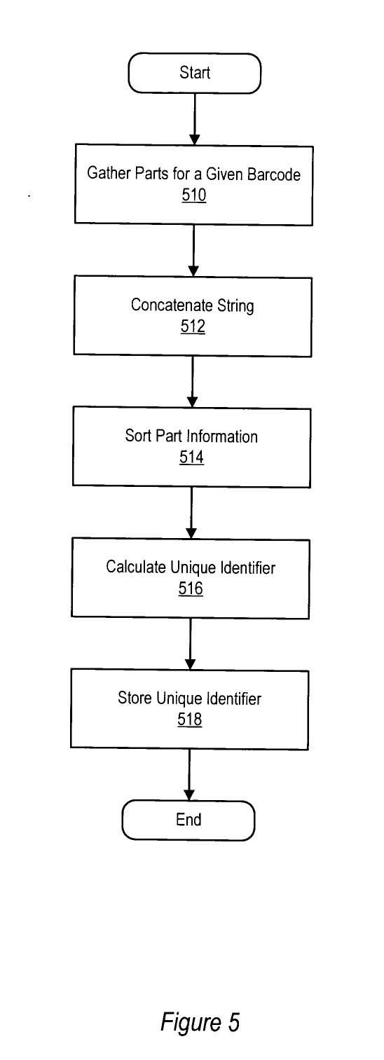

When creating the software stacks, it is desirable to create stacks for the combinations of software that are most often ordered. Accordingly, it is desirable to identify unique orders so that the combinations of software that are most frequently ordered can be prioritized when creating the software stacks. FIG. 5 shows one example of the operation of the system for calculating and identifying unique orders 260. More specifically, the system for calculating and identifying unique orders 260 starts operation by gathering the part information for a given system barcode at step 510. The given system barcode is a unique identifier for an actual target system (i.e., a potentially unique combination). The part information includes software part information and hardware part information. The software part information includes the software part (referred to as an SRV) and a part number that functions as a passed parameter to a software part (referred to as the infopart) for the software. Infoparts perform functional variations based upon the existence of an infopart in the order. The hardware part information includes the item, the sequence number and the detailed description of the hardware. The sequence number represents the slot of the hardware part. The sequence number is present when more than one of the same hardware component is present in a system (e.g., more than one hard drive, memory chip NIC card, etc. in a system).

After the part information is gathered at step 510, then the system concatenates a string containing all of the part information for a given order type at step 512. The given order type includes hardware order information, software order information, informational order information and base part order information. More specifically, the software order information includes the SRV of the order, the information order information includes the infopart, the hardware order information includes the item, sequence number and detailed description and the base part order information includes images of the SRVs contained within the base parts list.

After the string is concatenated at step 512, the string of part information is sorted at step 514. The string of part information is sorted by any known consistent sorting routine such that the part information is presented in a consistent order across the part information records.

After the string of part information is sorted at step 514, a unique order information value is calculated for the sorted string of part information. The unique order information value is calculated, for example, by calculating a unique integer for each type of unique order information. More specifically, a cyclical redundancy checking (CRC) algorithm is applied to the sorted part information and an integer value is provided by the algorithm.

The CRC algorithm may be any known CRC algorithm. Known CRC techniques ensure the accuracy of transmitting digital data. The transmitted digital data messages are divided into predetermined lengths which, used as dividends, are divided by a fixed divisor. The remainder of the calculation is appended onto and sent with the message. Upon receipt of the transmitted digital data message, the remainder is recalculated. If the remainder does not match the transmitted remainder, an error is detected. In the preferred embodiment, the CRC algorithm is used to calculate a unique order information value which reflects unique sorted part information.

After the unique order information value is calculated, this value is stored within the manufacturing database server 252 at step 518. The unique order information value is associated with an associated barcode. Storing the unique information value in the database server 252 at the barcode level facilitates and speeds analysis of groupings, averages, sums etc. of the unique order information because the number of records in the groups is significantly less at the barcode level than at the individual part per barcode level.

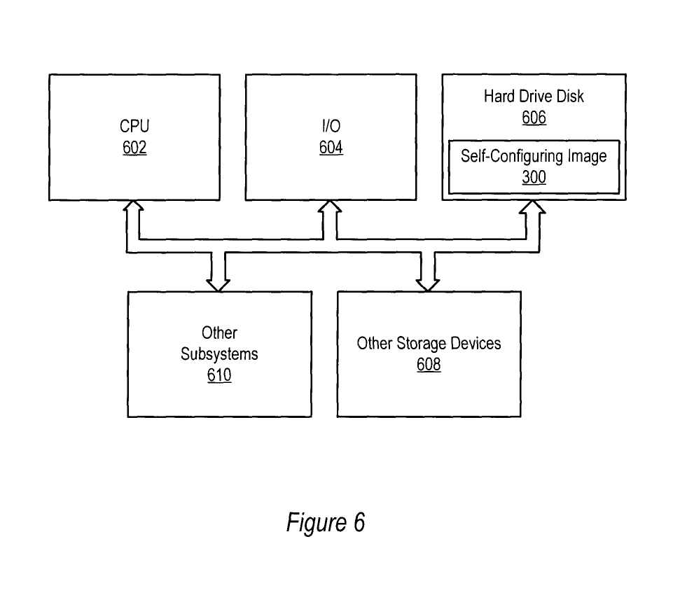

Referring to FIG. 6, a system block diagram of an information handling system 600 which has parts installed which are identified by the unique order information is shown. The information handling system includes a processor 602, input/output (I/O) devices 604, such as a display, a keyboard, a mouse, and associated controllers, a hard disk drive 606, and other storage devices 608, such as a floppy disk and drive and other memory devices, and various other subsystems 610, all interconnected via one or more buses 612. The self configuring image that may be installed according to the SSGEN methodology is installed onto hard disk drive 606. Alternately, the image may be installed onto any appropriate non-volatile memory.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Other Embodiments

Other embodiments are within the following claims.

For example, the above-discussed embodiments include software modules that perform certain tasks. The software modules may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for automatically installing a software image onto an information handling system, the method comprising:
reading an order for an information handling system;
reading an image manifest;
installing an image specified by the image manifest onto the information handing system as installed software; and
automatically configuring the installed software.

2. The method of claim 1, wherein the configuring includes:
executing order specific customizations.

3. The method of claim 1, further comprising:
determining whether all base components of the order are present in the image.

4. The method of claim 1, further comprising:
determining whether any subtract components are present in the image; and,
if any subtract components are present, then removing the subtract components from the installed software while automatically configuring the installed software.

5. The method of claim 1, further comprising:
determining whether any add components are present in the image; and,
if any add components are present, then installing the add components from the specified image contents.

6. The method of claim 1, wherein:
the automatically configuring is performed at a manufacturing site.

7. The method of claim 1, wherein:
the automatically configuring is performed at a customer site.

8. The method of claim 1, wherein:
the automatically configuring enables the installing to be performed in a networkless factory environment.

9. The method of claim 1, wherein:
the automatically configuring enables loading of an image directly from a non-volatile media.

10. The method of claim 1, wherein:
the automatically configuring enables a customized to order process to be performed in a remote manufacturing facility.

11. A apparatus for automatically installing a software image onto an information handling apparatus, the apparatus comprising:
means for reading an order for an information handling system;
means for reading an image manifest;
means for installing an image specified by the image manifest onto the information handing system as installed software; and
means for automatically configuring the installed software.

12. The apparatus of claim 11, wherein the means for configuring includes:
means for executing order specific customizations.

13. The apparatus of claim 11, further comprising:
means for determining whether all base components of the order are present in the image.

14. The apparatus of claim 11, further comprising:
means for determining whether any subtract components are present in the image; and,
means for removing the subtract components from the installed software while automatically configuring the installed software when any subtract components are present.

15. The apparatus of claim 11, further comprising:
means for determining whether any add components are present in the image; and,
means for installing the add components from the specified image contents when any add components are present.

16. The apparatus of claim 11, wherein:
the means for automatically configuring is located at a manufacturing site.

17. The apparatus of claim 11, wherein:
the means for automatically configuring stored within the information handling system and is executed at a customer site.

18. The apparatus of claim 11, wherein:
the means for automatically configuring enables the installing to be performed in a networkless factory environment.

19. The apparatus of claim 11, wherein:
the means for automatically configuring enables loading of an image directly from a non-volatile media.

20. The apparatus of claim 11, wherein:
the automatically configuring enables a customized to order process to be performed in a remote manufacturing facility.

21. A system for automatically installing a software image onto an information handling system, the system comprising:
a reading module, the reading module reading an order for an information handling system;
an image manifest module, the image manifest module reading an image manifest;
an installing module, the installing module installing an image specified by the image manifest onto the information handing system as installed software; and
a configuring module, the configuring module automatically configuring the installed software.

22. The system of claim 21, wherein the configuring module includes:
an executing module, the executing module executing order specific customizations.

23. The system of claim 21, further comprising:
a base component determining module, the base component determining module determining whether all base components of the order are present in the image.

24. The system of claim 21, further comprising:
a subtract component determining module, the subtract component determining module determining whether any subtract components are present in the image; and,
a removing module, the removing module removing the subtract components from the installed software while automatically configuring the installed software when any subtract components are present.

25. The system of claim 21, further comprising:
an add component determining module, the add component determining module determining whether any add components are present in the image; and,
an installing module, the installing module installing the add components from the specified image contents when any add components are present.

26. The system of claim 21, wherein:
the configuring module is located at a manufacturing site.

27. The system of claim 21, wherein:
the configuring module is stored within the information handling system and is executed at a customer site.

28. The system of claim 21, wherein:
the configuring module enables the installing to be performed in a networkless factory environment.

29. The system of claim 21, wherein:
the configuring module enables loading of an image directly from a non-volatile media.

30. The system of claim 21, wherein:
the configuring module enables a customized to order process to be performed in a remote manufacturing facility.
